(19) United States
(12) Patent Application Publication
(10) Pub. No.: US 2004/0108777 A1
(43) Pub. Date: Jun. 10, 2004

(54) Total balance power motor

(76) Inventors: Chin-Fa Yen, Taipei (TW); Kuo-Pin Yen, Taipei (TW)

Correspondence Address: Chin-Fa Yen, PO Box 82-144, TAIPEI, TW

(21) Appl. No.: 10/315,020

(22) Filed: Dec. 10, 2002

(51) Int. Cl. H02K 11/00

(52) U.S. Cl. 310/68 R

(57) ABSTRACT

A total balance power motor is disclosed. The power motor comprises an inner stator having a plurality of even number configured N-S magnetic poles, each magnetic pole being independent, alone formed into N or S main magnetic pole configuration and O (neutral) magnetic pole; an external rotor having a plurality of even number configured N-S magnet module, the N-S pole of the magnetic iron module being mounted apart at a continuous phase of 120 degree difference and each magnet module corresponding to four magnetic pole; and circuit structure including bridge circuit, position Hall IC, CPU and direct current which are applied by individual single module coil combined by bridge switch, which are interconnected and the operation thereof are subjected to the control of the CPU, obtaining polarity distribution, positioning system, speed control system, rotation synchronization and synchronous detection and speed control.

### BACKGROUND OF THE INVENTION

(a) Technical Field of the Invention

The present invention relates to a total balance power motor, and in particular, a power motor which provides fast rotation, large torque and high efficient power motor which saved energy.

(b) Description of the Prior Art

Conventionally motors are mostly comprised of a single phase or three phase 3:2 configuration and therefore, the power motor is not balanced. By means of the unbalanced magnetic field the rotor rotates to output power. However, the conventional motor is provided with a cylindrical rotor having permanent magnet, and is enclosed at the outer edge of a stator conjugated iron having stimulating magnetic coils, and the center of the rotor is provided with a rotating shaft and the rotating shaft passes through the center hole of the stator so that the rotor rotates concentrically with the stator.

In view of the above combination, a conventional motor has the following drawbacks.

(1) Due to the unbalanced structure to produce attraction force and repelling force of unbalance interchange, the unbalance will cause exhaustion of torque and energy.

(2) Conventional power motor is either large torque with low rotation or high rotation with low torque. It is difficult to obtain a high torque with high rotation.

(3) Conventional power motor causes a “rear end” attraction which causes a power loss.

Accordingly, it is an object of the present invention to provide a total balance power motor which eliminates the drawbacks.

### SUMMARY OF THE INVETION

Accordingly, it is an object of the present invention to provide a total balance power motor an inner stator having a plurality of even number configured N-S magnetic poles, each magnetic pole being independent, alone formed into N or S main magnetic pole configuration and O (neutral) magnetic pole; an external rotor having a plurality of even number configured N-S magnet module, the N-S pole of the magnetic iron module being mounted apart at a continuous phase of 120 degree difference and each magnet module corresponding to four magnetic pole; and circuit structure including bridge circuit, position Hall IC, CPU and direct current which are applied by individual single module coil combined by bridge switch, which are interconnected and the operation thereof are subjected to the control of the CPU, obtaining polarity distribution, positioning system, speed control system, rotation synchronization and synchronous detection and speed control.

Yet another object of the present invention is to provide a total balance power motor wherein a plurality of magnetic poles of the inner stator are provided with 6 modules, each module including four magnetic poles amounting to 24, the number being increased or decreased according to the size of the motor.

A further object of the present invention is to provide a total balance power motor, a plurality of magnets of the external rotor are provided with two modules, each module including three N-pole magnets, and three S-pole magnets.

Still another object of the present invention is to provide a total balance power motor, wherein the CPU changes to be corresponding polarity of the four magnetic pole when the magnet is moved each of the magnetic pole distance, and maintains variation so as to maintain the magnetism coordination of the magnet of the external rotor to generate continuous operation.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view of the structure of a motor in accordance with the present invention.

FIG. 2 is a circuit structure view in accordance with the present invention.

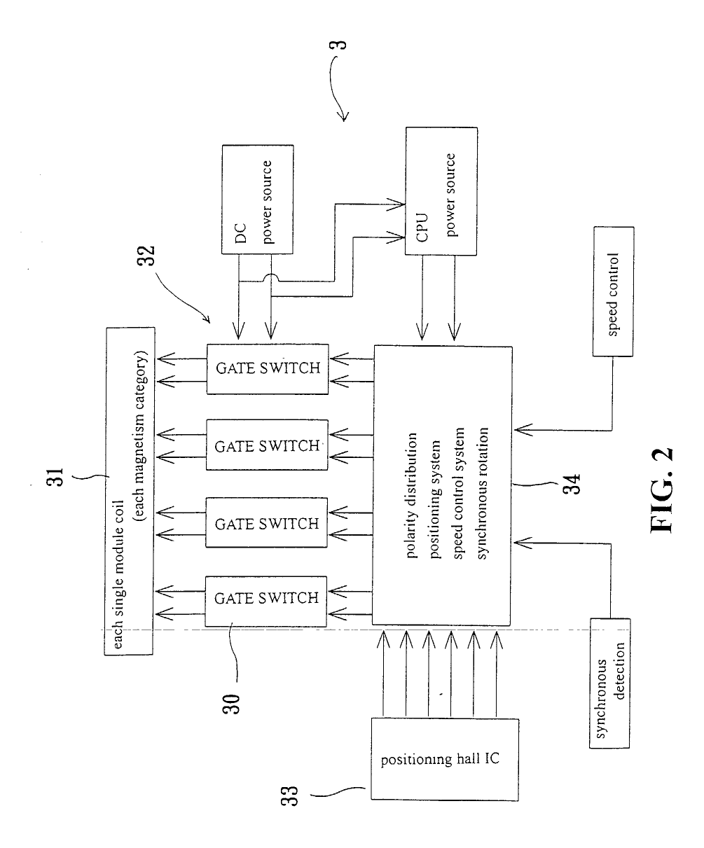

FIG. 3 is a partial circuit diagram in accordance with the present invention.

FIG. 4 is a schematic view showing the action of a preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

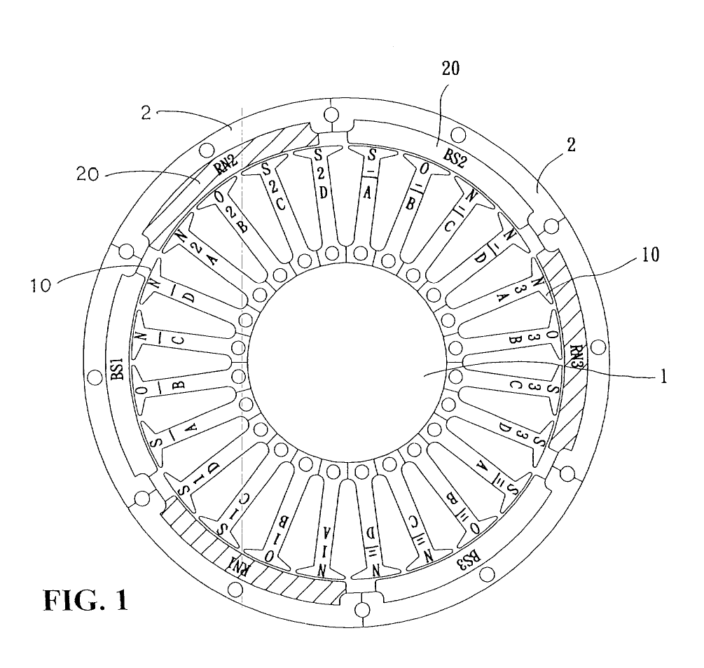

Referring to FIG. 1, there is shown a total balance power motor which employs an external rotor motor and the structure comprises basic units to form an external motor. As shown in the figure, there is shown the structure of the inner rotor 1 and external rotor 2, and circuit structure 3. In accordance with the present invention, the power motor is characterized in that: the inner stator 1 having a plurality of even number configured N-S magnetic poles 10, each magnetic pole 10 being independent, alone formed into N or S main magnetic pole configuration and O (neutral) magnetic pole, in the present invention, six modules are shown and each module has four magnetic poles being totaled to form 24 magnetic poles. The magnetic poles are respectively corresponding to a plurality of magnets 20 of the external rotor 2.

The external rotor 2 is provided with a plurality of even number configured magnet 20. In the present invention, three N magnetic pole magnets (N1, N2, N3), three S magnetic pole magnets (S1, S2, S3), and six magnets are employed. In view of the configuration, a plurality of N pole and S pole magnet 20 are mounted apart at a continuous phase of 120 degree difference and each magnet module corresponding to four magnetic poles 10.

The four magnetic poles 10 include two magnetic poles 10 with opposite to the magnetism of the magnet 20, a magnetic pole 10 with a neutral magnetism, and a magnetic pole 10 similar to the magnetism of the magnet 20 (for instance, N, O, S, S or S, O, N, N) and there are replacing one another continuously and in combination with the change of the magnetic pole of the external rotor 2 magnet 20 so as to maintain continuous rotation.

With regard to the circuit structure 3, there is shown the flowchart and circuit diagram. A bridge switch 30 together with the bridge circuit 32 used in operating the individual single module coil are used in showing the magnetism change of each module of magnetic pole 10, and the positioning Hall IC 33 can provide bus detection of the magnet 20 of the external rotor 2 so that the external rotor 2 in the course of beginning to rotate and stop to rotate can correspond to the destined magnetic pole 10 position of the inner stator 1. Additionally, the bridge 30 and the positioning Hall IC 33 are connected to a CPU 34 and is then connected to a DC supply. Thus the CPU is in operation to obtain polarity distribution, positioning system, speed control system, speed synchronization and the synchronized detection and speed control.

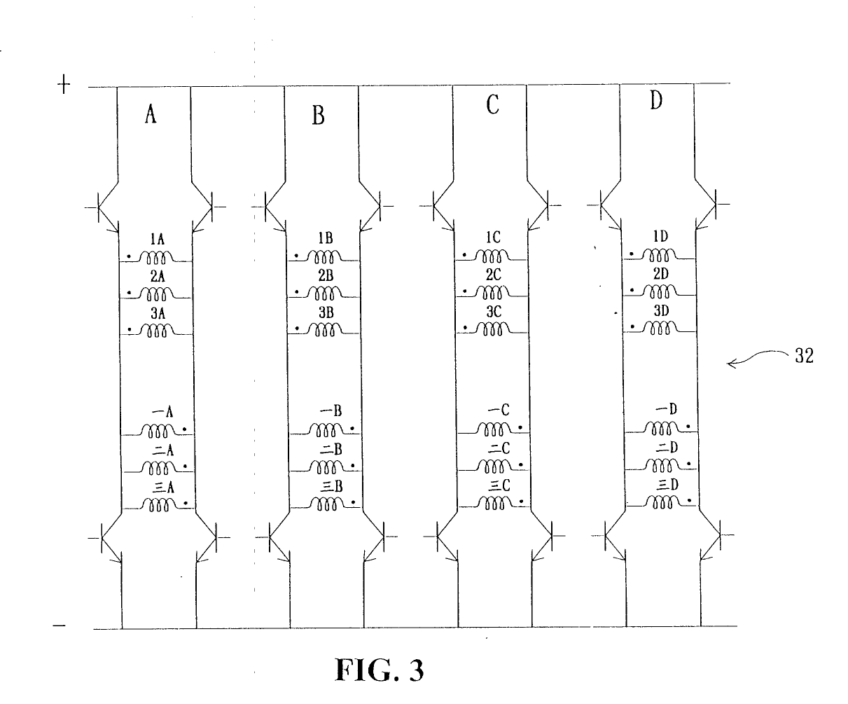

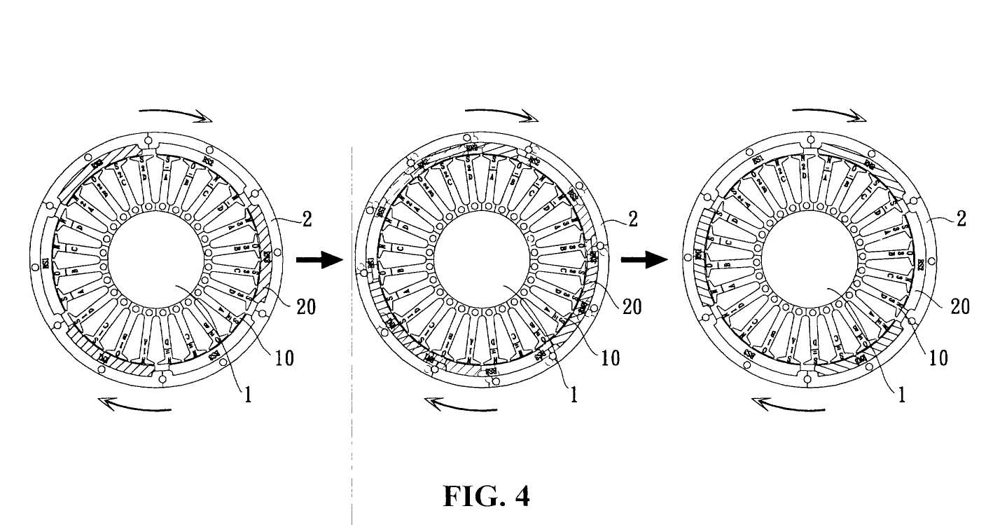

In the application of the power motor of the present invention, when direct current (DC) is applied, the motor rotates immediately. Referring to FIGS. 3 and 4, showing the rotation of the motor, the operation of the external rotor 2 is explained thereafter.

At the initial operation of the external rotor 2, using N1 magnet of the magnet 20 of the N-pole as an example, the N1 magnet 20 produces clockwise direction of operation as shown in FIG. 4, this is due to the fact that the N1 magnet 20 is provided with the four magnetic poles 10 and is affected by the S magnetism of the magnetic pole 10 and the attraction force of the magnetic pole 10 with S magnefism.

At the same time, in combination with the magnetic pole 10 of N magnetism at the utmost end located at the module of the magnetic pole 10 which provides the repel force to encourage rotation. In order to avoid the balance of attraction and repelling due to the application of the even number magnetic pole 10, and avoid reverse pull phenomenon the low efficient magnetic pole 10 is designed into a “O” or neutral magnetic pole without affecting the operation, and not exhausting power. Thus, the unbalanced magnetic pole products action with N1 magnet 20, including the attraction at the front end and the pushing at the rear end, thus, the unbalance condition can achieve a smooth rotation.

When the N1 magnet 20 slowly moves to the position of S1 magnet 20, the four magnetic poles 10 with S, O, N, N magnetism corresponding to the S1 magnet 20 which is controlled by the polarity distribution of CPU 34 has already changed to N, O, S, S magnetic pole configuration (and S3 magnet 20 when gradually changed to N1 position being corresponding to magnetic pole 10 has also changed from N, O, S, S to S, O, N, N magnetic pole configuration).

As a result, N1 magnet 20 is continuously maintained at attraction force and repelling force with no resistance but providing perfect operation power. Similarly, all the N pole and S pole magnet enclosed by the external rotor 2 with such unbalanced power combination to provide high speed rotation, high efficiency and large torque.

The balance of the power motor is on that: the external rotor 2 is provided with three N pole magnets 20 spaced at an angle of 120, and three S-pole magnet 20 and the inner stator 1 is provided with six modules, each module having four magnetic poles 10, amounting to twenty-four magnetic poles 10. The unbalance of the power motor is that in the combination of the twenty-four magnetic poles 10, each magnetic pole 10 can independently be N, S, or O magnetic pole. The change of polarity is controlled by CPU 34. Due to the fact that when each magnet 20 moves a distance of each magnet 10, the corresponding four magnetic poles 10 have polarity changed earlier and therefore, attraction force, no action or pushing force perfect combination is obtained. Thus, a stable high effective power output is achieved and a perfect balance of an unbalance structure is obtained in accordance with the present invention.

When the external rotor 2 begins to rotate, and the magnet 20 moves away from corresponding magnet 10, attraction force at the rear end is formed and the efficiency is reduced. Thus, in accordance with the present invention, the drawback of the attraction at the rear end is formed and the efficiency is reduced. Thus, in accordance with the present invention, the drawback of the attraction at the rear end is overcome.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A total balance power motor comprising:
(a) an inner stator having a plurality of even number configured N-S magnetic poles, each magnetic pole being independent, alone formed into N or S main magnetic pole configuration and O (neutral) magnetic pole;
(b) an external rotor having a plurality of even number configured N-S magnet module, the N-S pole of the magnetic iron module being mounted apart at a continuous phase of 120 degree difference and each magnet module corresponding to four magnetic pole; and
(c) circuit structure including bridge circuit, position Hall IC, CPU and direct current which are applied by individual single module coil combined by bridge switch, which are interconnected and the operation thereof are subjected to the control of the CPU, obtaining polarity distribution, positioning system, speed control system, rotation synchronization and synchronous detection and speed control.

2. The power motor of claim 1, wherein a plurality of magnetic poles of the inner stator are provided with 6 modules, each module including four magnetic poles amounting to 24, the number being increased or decreased according to the size of the motor.

3. The power motor of claim 1, wherein a plurality of magnets of the external rotor are provided with two modules, each module including three N-pole magnets, and three S-pole magnets.

4. The power motor of claim 1, wherein each magnet of the external rotor is corresponding to each modules of the inner stator having four polarity respectively including two magnetic poles opposite to the polarity of the magnet, one neutral magnetic pole and a magnetic pole similar to the magnetism of the magnet.

5. The power motor of claim 1, wherein the CPU changes to be corresponding polarity of the four magnetic pole when the magnet is moved each of the magnetic pole distance, and maintains variation so as to maintain the magnetism coordination of the magnet of the external rotor to generate continuous operation.
